(19) United States
(12) Patent Application Publication
(10) Pub. No.: US 2007/0109401 A1
(43) Pub. Date: May 17, 2007

(54) Monitor with integral interdigitation

(75) Inventors: Lenny Lipton, Los Angeles, CA (US); Josh Greer, Beverly Hills, CA (US)

Correspondence Address: SMYRSKI LAW GROUP, A PROFESSIONAL CORPORATION, 3310 AIRPORT AVENUE, SW, SANTA MONICA, CA, 90405, US

(73) Assignee: Real D

(21) Appl. No.: 11/598,950

(22) Filed: Nov. 13, 2006

Related U.S. Application Data
(60) Provisional application No. 60/736,617, filed on Nov. 14, 2005.

(51) Int. Cl. H04N 13/04

(52) U.S. Cl. 348/59

(57) ABSTRACT

An autostereoscopic system is provided. The autostereoscopic system comprises a video source configured to provide video content in a video source format and a monitor system coupled to the video source and configured to receive the video content in the video source format. The monitor system comprises an interdigitation module configured to receive the video content in the video source format and interdigitate the video content in the video source format into an autostereoscopic image, a video rendering module coupled to the interdigitation module configured to receive the autostereoscopic image from the interdigitated module and provide a rendered autostereoscopic image, a display coupled to the video rendering module and configured to receive the rendered autostereoscopic image, and a lenticular screen held in juxtaposition with the display. Temperature compensation may be employed within the system.

The present application claims the benefit of U.S. Provisional Patent Application 60/736,617, entitled “Monitor with Integral Interdigitation,” inventors Lenny Lipton and Josh Greer, filed Nov. 14, 2005.

### BACKGROUND OF THE INVENTION

1. Field of the Invention

The present invention relates generally to the art of autostereoscopic monitors, and more specifically to making an autostereoscopic monitor transparent to any content delivery system or network infrastructure.

2. Description of the Related Art

Panoramagram autostereoscopic monitors require information that is substantially different from that which is supplied to a planar or conventional display. A conventional display provides a single perspective view. When the observer looks at the display, the eyes are both accommodated for the plane of the screen and converged on the plane of the screen. When looking at a panoramagram-type autostereoscopic display, while the eyes may be accommodated for the distance of the display screen, the eyes converge at different distances in accordance with the display's parallax information and the result is perceived as a stereoscopic image. The general technique of using either refractive optics or a raster barrier as a selection device has been thoroughly described in the literature, such as Takanori Okoshi's Three-Dimensional Imaging Techniques, published in 1976 by the Academic Press of New York.

The almost century-old technique of the panoramagram involves multiple perspective views that are sliced or interdigitated, to create an image map that is used in accordance with the aforementioned selection devices. The selection device is typically in close proximity to the mapped or interdigitated image. The purpose of the selection device is to provide an appropriate perspective of the desired image or images to the appropriate eye. In this way an image can be created with information for binocular stereopsis, just as the observer would see in the visual field.

In order to have a stereoscopic effect two or more images are required. In the classical panoramagram, the arrangement of images can be thought of as occurring in columns and stripes. Columns repeat, and within each column there are image stripes. One can conceive of taking a series of photographs that provide the multiple perspective images and these images can be, in concept at least, cut up with a scissors and then laid together in stripes, each sequence of stripes forming a column; and it is the property of the raster barrier or the refractive lenslets to provide image selection.

The advent of flat panel electronic displays and their high quality has led inventors to turn their attention to the application of the panoramagram to such display devices. The application of the panoramagram to flat panel displays represents a progression from hard copy to flat panel. A flat panel display has many interesting characteristics and benefits. Flat panel displays, as the name suggests, are flat, while CRT displays lack the perfect flatness of a flat panel, thus providing a huge challenge for designers. It is not simply the flatness that is a crucial element in the successful application of the panoramagram to electronic displays. Positions of pixels and sub-pixels in a flat panel display are known without equivocation, because they form a Cartesian grid that is addressed electronically, and each sub-pixel is associated with an appropriate optical element.

The present design addresses refractive lenticular screens that are corduroy-like, or resemble a washboard surface. Refractive optics are preferred to the alternative raster barrier technique because refractive optics lose very little light. The raster barrier has notoriously low étendue, and also has a significant pattern noise artifact since, after all, one is looking through a ruling barrier. Nevertheless, in the present discussion, although refractive optics offer distinct advantages, the technology is indifferent to whether the selection device is a lenticular screen or a raster barrier, since the principle described here applies to either case. Indeed, the two forms of selection devices are optically interchangeable in most panoramagram designs.

Specific problems that need to be addressed in order to have a successful commercial embodiment of an electronic display panoramagram include the fact that each monitor or display must have a specific mapping pattern that matches the pitch and orientation of the lens sheet. Content interdigitated for one monitor model may not playback properly on another since the columns and image stripes within the columns are specific to a lens sheet formulation. The distribution of pre-mapped or pre-interdigitated content in effect blocks the use of that content on all but one monitor model.

Another problem area with commercial electronic display panoramagram is in the manufacturing area. The individual lenslets of the lens sheet must be in precise juxtaposition with the sub-pixel elements of the electronic display, to within about a micron precision. Also, there are issues with the relative coefficients of expansion of the lens sheet and the display.

It would be beneficial to address and overcome the issues present in previously known panoramagrams, and to provide a commercial display panoramagram design having improved manufacturing qualities and viewing properties over devices exhibiting the negative characteristics described herein.

### SUMMARY OF THE INVENTION

According to a first aspect of the present design, there is provided an autostereoscopic system wherein video content is provided in a video source format to a video display having a lenticular screen arranged in juxtaposition with the display, an improvement comprising an interdigitation module incorporated as part of an electronics module associated with the video display, wherein the interdigitation module receives the video content in the video source format and maps the video content in the video source format into multiple perspectives of an autostereoscopic image.

According to a second aspect of the present design, there is provided an autostereoscopic system. The autostereoscopic system comprises a video source configured to provide video content in a video source format and a monitor system coupled to the video source and configured to receive the video content in the video source format. The monitor system comprises an interdigitation module configured to receive the video content in the video source format and interdigitate the video content in the video source format into an autostereoscopic image, a video rendering module coupled to the interdigitation module configured to receive the autostereoscopic image from the interdigitated module and provide a rendered autostereoscopic image, a display coupled to the video rendering module and configured to receive the rendered autostereoscopic image, and a lenticular screen held in juxtaposition with the display.

These and other objects and advantages of the present invention will become apparent to those skilled in the art from the following detailed description of the invention and the accompanying drawings.

### DESCRIPTION OF THE DRAWINGS

FIG. 1A is a block diagram showing the conventional architecture and infrastructure of content delivery for an autostereoscopic monitor;

FIG. 1B is a schematic representation of the n-tile format and the interdigitation processing required producing a suitable mapped panoramagram image;

FIG. 1C shows the process for producing mapped interdigitated images, but starting with a stereo pair;

FIG. 1D illustrates the process of producing mapped interdigitated images, but starting with a planar image and a depth map;

FIG. 2 shows the architecture of the invention described providing on-board or integral interdigitation;

FIG. 3A is a perspective representation showing a Winnek angled lens sheet in juxtaposition with a flat panel display;

FIG. 3B shows a cross-sectional representation of sub-pixels and associated lenticules;

FIG. 4A shows a cross-sectional representation of a display and a lens sheet in a symmetrical location for a viewing zone;

FIG. 4B is a cross-sectional representation of a display and a lens sheet in an asymmetrical, or off-axis, location for a viewing zone; and

FIG. 4C shows a cross-sectional representation of a display and its associated lenticular sheet, with a reduced angular extent for a viewing zone.

### DETAILED DESCRIPTION OF THE INVENTION

The present design overcomes many difficulties in prior designs, where the interdigitation process is separate and not integral to the monitor. The present design incorporates the interdigitation function within the monitor by employing an interdigitation hardware circuit within the monitor that processes or maps multiple perspectives or similar dimensional information and this feature has the additional ability to allow the monitor to adapt to temperate variations and to maintain alignment calibration determined at the time of manufacture.

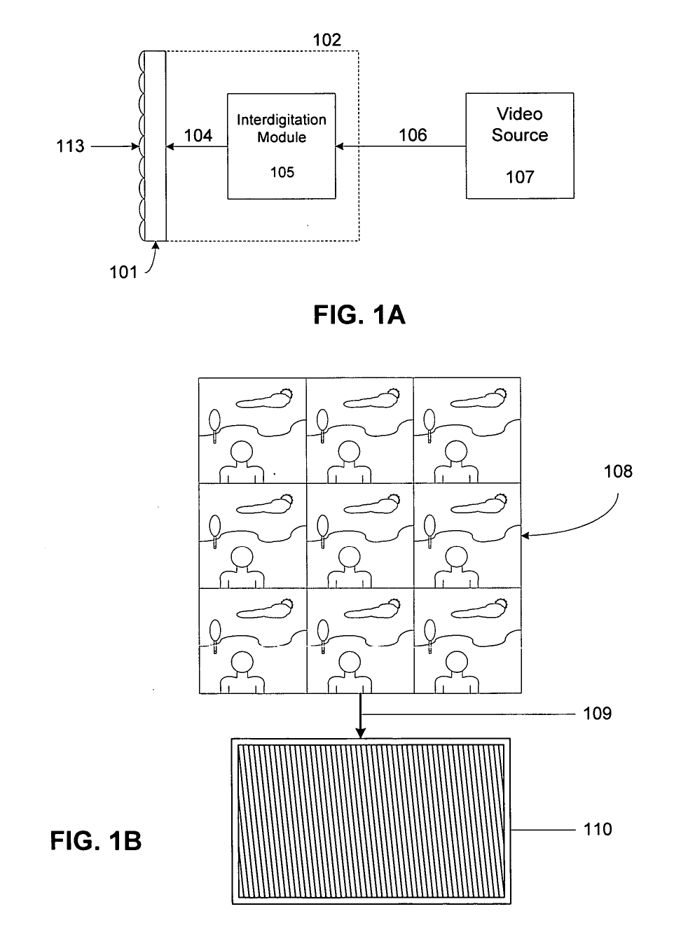

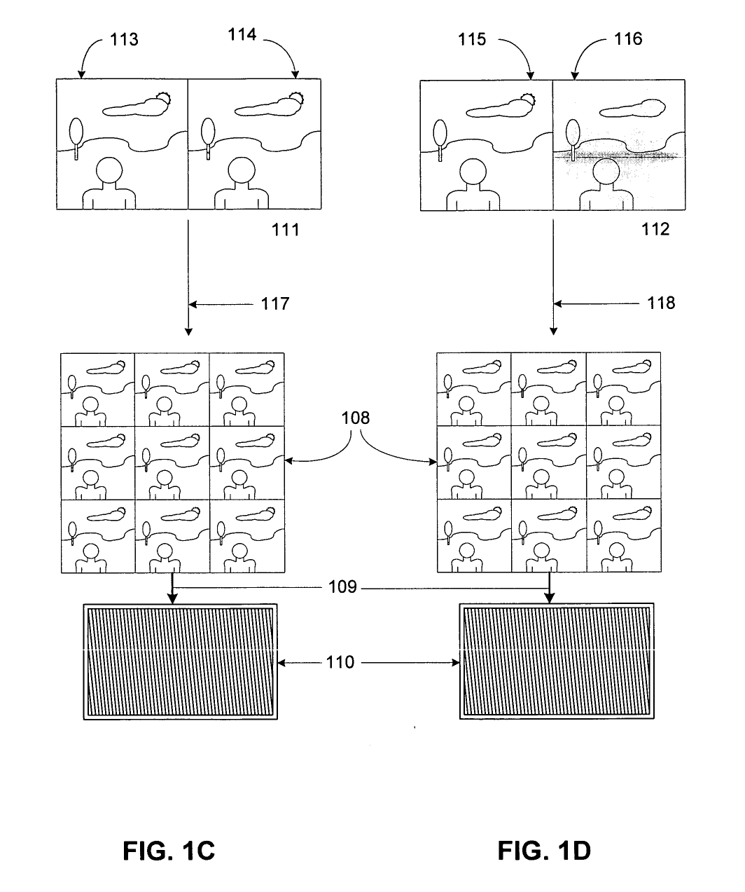

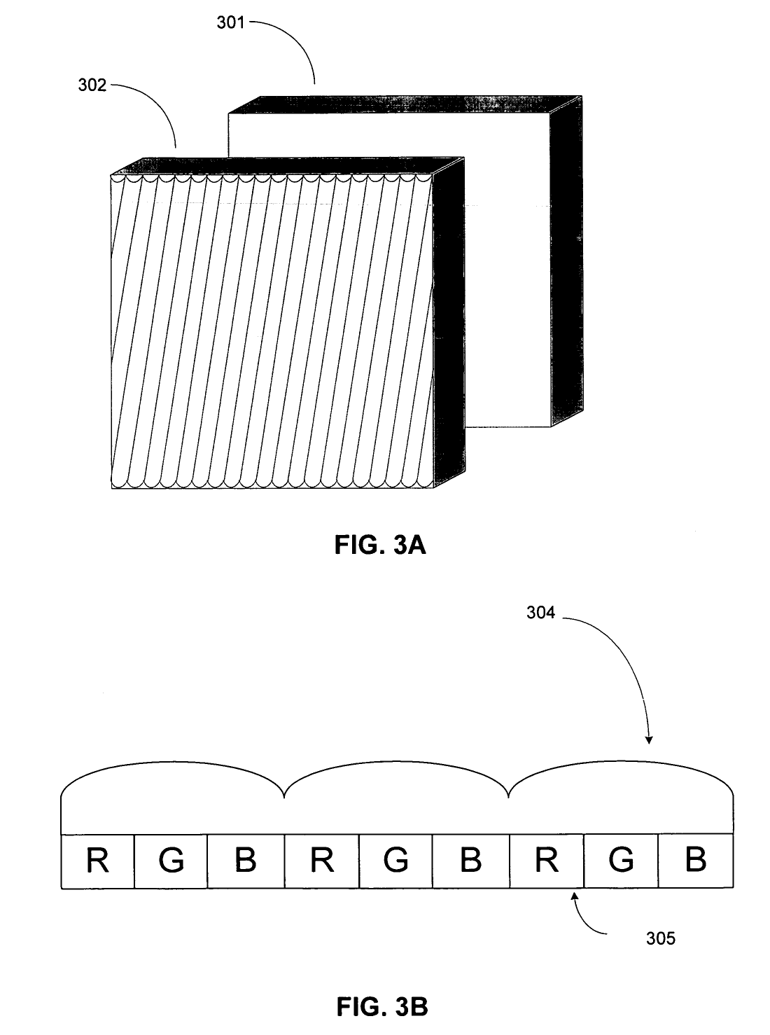

With reference to FIGS. 1B and 3A, the present design follows the Winnek (U.S. Pat. No. 3,409,351) formulation in which the lens sheet (or indeed raster barrier as given by Sandor in U.S. Pat. No. 5,519,794) is tipped to the edge of the display. Imagining the individual lenticules intersecting, the boundary lines where they intersect form an axis, and in a traditional panoramagram used for a hard copy the axis is invariably parallel to the vertical edge of the display. In the case of the Winnek formulation the axis is not parallel—it is tipped. The advantage of using the Winnek formulation for a flat panel display is that the pixel density of flat panel displays is much lower than that for photographic or photomechanical hard copy. With fewer pixels to deal with, and with significant interstices between the pixels or sub-pixels, the horizontal magnification properties of the lens sheet exacerbate the extent and the visibility of the interstices between sub-pixels, producing significant pattern noise, and even color patterns that have been described as “color moiré.”

By tipping the lens sheet, the present design not only eliminates the color moiré, but also subdues pattern noise. Although the Winnek formulation is discussed herein, what is described here is, without loss of generality, applicable to the traditional panoramagram approach in which the lens axes, or the lens boundary axes, remain parallel to the vertical edge of the display.

FIG. 1A shows a top view of an autostereoscopic monitor 102 and content delivery system 107, 106, with lens sheet 113 shown diagrammatically with a cross-sectional view of a series of lenticules covering electronic display 101. Electronic display 101 is a conventional flat panel display. Electronic display 101 may be a liquid crystal display or a plasma display for example. The precise type of display is immaterial as long as it provides a Cartesian coordinate based system of pixels or sub-pixels which can be juxtaposed with the lens sheet of the present design.

In FIG. 1A, a video delivery system or video source 107 provides a signal 106 to monitor 102 that has a display screen 101. The monitor's electronics take the video signal and display it by means of what is called pipeline 104 onto display 101. The processing of the signal is according to standard techniques employed for the display of raster or video graphics—the kind that have been employed for many decades for television receivers and computer graphics monitors. There is no additional processing of the signal. Because the nature of flat panels is digital, a digital connection is supplied at 106 and the signal provided by video source 107 is of a digital nature. Video source 107 might be a PC, a DVD, a playback device, or a network. FIG. 1B shows in some detail the nature of the signal. Element 105 represents an interdigitation module, discussed in detail below, which receives the signal from video source 107 and interdigitates the video signal for display using display screen 101.

Assuming video source 107 is a PC or a network client, the image information delivered to video source 107 is of a nature of multiple perspective views as shown in tile views 108. In particular, with reference to FIG. 1B, this type of an image is called the “n-tile” format. Nine tile views are shown here, with a progession of nine perspective viewpoints, any two of which form a stereo pair. But n-tile views may be made up of any number of perspective views. Interdigitation or mapping process 109 is shown in FIG. 1B. One specific algorithm, available from Real D Corporation of Beverly Hills, Calif., is called “Interzig,” and Interzig meets the needs of the Winnek angle formulation. The Interzig algorithm is described in Autostereoscopic Pixel Arrangement Techniques, U.S. Patent Publication No. 2002/0011969.

In this discussion this process is called by its generic name “interdigitation” since the art described herein is not limited to the specific Interzig algorithm but is given by way as an example.

Image map 110 schematically shows the result of mapping the n-tile image 108 by means of interdigitation algorithm 109. Here we show columns of images. Within each column is a sub-pixel formulation which will be written on display 101 and viewed through lens sheet 113. Therefore, image map 110 is a map which is created out of the multiple perspective views of 108 n-tile format, and is then interdigitated according to the interdigitation algorithm 109 to produce a series of repeating columns of a certain pitch, said pitch similar to the pitch of the lens sheet 113. Within each column, according to the specific interdigitation algorithm 109, there will be an arrangement of sub-pixels. The sub-pixels are arranged compatibly with lens sheet 113 so that the observer will see a panoramagram. In addition to the interdigitation function, and prior to that function, the system scales the image to allow it to match the native resolution of the display panel. The scaling process is beneficial since the size of the individual n-tiles is not likely to be the same as the monitor's native resolution. A complete description of the process is given in the aforementioned U.S. Patent Publication 2002/0011969, which is incorporated herein by reference.

Scaling and then interdigitation in no way harms the stereoscopic information. Moreover, depending upon the media player involved, a very wide variety of compression algorithms may be used. Mapping of the n-tile images to screen subpixels is an efficient compression method but a more precise but computationally intensive method is to perform a proportional averaging operation for subpixels to be mapped under each lenticule. In addition, the scaling of the n-tile images can asymmetrical. In other words, a source n-tile frame of any aspect ratio may be mapped to the screen as long as the play back function can restore the aspect ratio or proper shape of the image.

The foregoing describes displaying autostereoscopic images of the panoramagram type on an electronic display 101 with lens sheet 113 in monitor 102 and in association with content delivery system (106, 107). To make the content agnostic with regard to a specific monitor model, the present design provides several precursor formats (described below), one of which is the n-tile format, as shown at 108, which is processed at interdigitation algorithm 109. Interdigitation algorithm 109 includes constants that can be monitor specific and changeable, so that the mapping at image map 110 conforms to the requirements of the display 101 in combination with lens sheet 113.

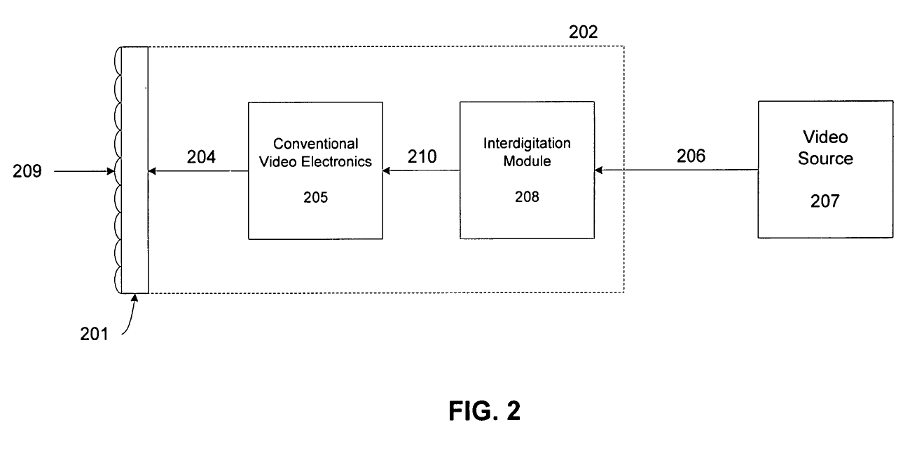

So that the individual lenslets 304 of FIG. 3B of lens sheet 302 of FIG. 3A are in precise juxtaposition with the sub-pixel elements 305 (labeled R for red, G for green, and B for blue), the present design mechanically locates the lens sheet 302 with respect to the sub-pixels. By sliding or rotating lens sheet 302 and observing the resultant patterns, the lens sheet 302 and the display or display screen 301 can be adequately aligned. This mechanical alignment is sufficient for low-volume manufacture, but inadequate for high volume. By making the changes described herein, and by incorporating an interdigitation board into the monitor as shown in FIG. 2, a convenient software adjustment rather than a hardware adjustment can be made. This greatly speeds up the manufacturing process. It allows for the proper location of the viewing zones, and also allows for the optimization of their angular extent. Instead of mechanically moving the lens sheet the underlying pixel map can be moved in an equivalent way to produce proper juxtaposition of the image elements and the lens sheet.

Significant lens sheet and pixel alignment issues exist with respect to the relative coefficients of expansion of the lens sheet and the display typically manifesting itself as the monitor is turned on and heats up from room temperature, approximately 70 degrees Fahrenheit, to about 110 degrees steady state operation. Great precision in alignment is required over the operating temperature range. With the passage of time, especially within the first hour of operation, as the monitor warms up, the display pixels expand differentially with respect to the lens sheet. After about an hour both reach a steady state. Therefore, the interdigitation constants (pitch for example) that are used when the monitor is cold do not apply when the monitor is warm. This will change the angular extent of the viewing zone—reducing it—because of improper juxtaposition of the pixels with respect to the individual lenslets of the lens sheet. This refers back to the fact that the image structure is actually made up of columns and stripes, and within these stripes exist the multiple perspective views that have been mapped according to the interdigitation algorithm at the sub-pixel level.

FIG. 2 is distinguished from FIG. 1A in that it incorporates the interdigitation function as a firmware solution and is part of the monitor proper. In FIG. 2 the display 201 (top view) is covered with a lens sheet 209. The format provided by video source 207 may be as shown in FIGS. 1B, 1C, or 1D, and is generically referred to herein as a formatted video source, encompassing any type of raw video source (NTSC, PAL, various high definition protocols, etc.) provided in a format such as n-tile (FIG. 1B), stereo pair (FIG. 1C), or planar image plus depth map (FIG. 1D). The video streams into the monitor 202 in the form of a formatted video source via cable 209. The formatted video source is processed by the interdigitation board or module 208, and the resultant video then flows by means of path 210 to conventional video electronics 205, and then to the display screen by path 204.

Source 207 represents a standard video signal or formatted video source which incorporates information in the form as shown in FIG. 1B as 108, in FIG. 1C as 111, or in FIG. 1D as 112—respectively as an n-tile format, as stereo pairs, or as a planar image plus depth map. The interdigitation board 208 calculates, by algorithmic means, appropriately mapped views in accordance with the requirements of a panoramagram display as described above. Interdigitation board 208 provides, at a minimum, the processing of the n-tile images 108, which are then interdigitated by process 109, whose function is incorporated within board 208 to produce the interdigitated map, as shown in 110. Alternatively, the image information provided by 207 may be in the form of stereo pairs shown at 111. These stereo pairs are then interpolated to produce the multiple perspective views in the n-tile format. The n-tile format could be substituted by storing the perspective views by any one of a number of means or arrangements. Here the multiple perspectives in the n-tile images 108 are provided in this tic-tac-toe-like format, but the design is not limited to that way of arranging the perspective views.

Alternatively, following the flow in FIG. 1C, stereo pairs are available and the system interpolates the in-between views to produce the multiple perspectives as shown in images 108, which are finally employed to produce the mapped interdigitated image 110. Interpolation may take virtually any form, including but not limited to averaging, weighted averaging, and other mathematical or interpolation methods. In terms of image production, interpolation can involve producing any number of perspective views that are required for the display, not necessarily nine as given here. In addition, extrapolation is also possible to extend the effective interaxial separation to heighten the stereoscopic effect.

The image pairs, left 113 and right 114, may be interchanged as long as the device keeps track of or has knowledge of the location of the perspective images. Most importantly, two images are available that are a bona fide still or moving image stereo pair that have the parallax information required for producing a panoramagram by interpolation or extrapolation. After the multiple perspectives have been derived, the system interdigitates as explained using FIG. 1B.

As a final alternative we show, in FIG. 1D in 112, a depth map image plus a planar image, the planar image being 115 and the depth map 116. Depth maps are generally well understood. Many computer graphics programs output depth maps that produce in shades of gray depth information which, when used in combination with the planar image, can reconstruct a multiple perspective view. The image is processed in accordance with algorithm 118 which is a process for extracting multiple perspectives 108 from the depth map 112. After the multiple perspectives have been created, the system interdigitates as explained above with respect to FIG. 1B.

The system begins with the precursor n-tile format, a stereo pair, or a planar image plus a depth map, and extracts—in the case of the last two—the n-tile views, and then produces out of the n-tile views, by the proper interdigitation algorithm, a mapped image that is specific to a monitor model whose lens sheet is of a certain optical design. In the case of any of these precursor formats—whether n-tile, stereo pair, or planar image plus depth map—the image can be compressed and sent along an information pipeline using standard compression techniques, without loss of stereoscopic information. In addition, because the interdigitation constants are specific to the monitor on which the signal is being played back, there will be a proper map with proper juxtaposition of the sub-pixels with regard to the individual lenticular picture elements.

FIG. 3A shows lens sheet 302 and electronic display 301. Electronic display 301 has the usual Cartesian arrangement of sub-pixels, whose sub-pixels are addressed on the screen with complete specificity There is potentially no ambiguity with respect to their juxtaposition with the lenslets elements of lens sheet 302, which is required with traditional panoramagram techniques. In this case the Winnek angle formulation is shown, but the design is not tied specifically to Winnek's formulation and can use the traditional vertical-going lens sheets with lens boundaries vertical to the vertical edge of the display. In addition, in the place of the refractive lens sheet, a raster barrier may be employed, as previously noted.

In more detail, we see the individual lenticules as pointed out in 304, in juxtaposition with sub-pixels 305, which are, as noted, labeled R G B to stand for red, green, and blue picture elements. Again, this arrangement will work with any flat panel display, whether a liquid crystal, plasma, or light-emitting diode display.

The depth signal information may arrive in three different format types and then may be turned into a panoramagram display for the particular monitor model. As far as the video distribution infrastructure is concerned, whether a DVD player, a PC, a network, or a client within the network, the video is normal or standard and there are no changes to the distribution infrastructure. The video signal can be used to carry any one of the three formats described, which is then processed internally in the monitor. Networking issues and video format issues do not, given this improvement, represent a bottleneck to the deployment or distribution of autostereoscopic monitors. Content distributors are broadcasting a standard video or computer signal. The video signal may look peculiar on an ordinary planar monitor—it may be in the n-tile format or the stereo pair format or the depth map format—but as far as distribution compression techniques are concerned, this is a normal video signal with normal video characteristics. Once the image arrives at the monitor by means of a header, for example, or some kind of signifier, as far as the monitor is concerned, it is then handling a normal video signal.

While generally described with respect to an on-board interdigitation board, module or device within the monitor, the invention is not strictly limited to incorporating an interdigitation device within the monitor, but the interdigitation function may be performed outside of or separate from the monitor. Due to monitor variations, temperature effects, and differences in lens sheets, for example, uniform interdigitation for multiple monitors may not yield ideal results.

With regard to FIG. 2, the monitor-integral processing board 208 processes the signal through several stages (as per FIGS. 1B, 1C, and 1D, if required) and eventually produce the interdigitated image.

Any protocol of video is a suitable candidate for content delivery in the context of this disclosure. Such protocols include PAL, NTSC, ATSC, and any video signal that may be displayed on a computer graphics or high-end electronic display. Moreover the source of the image may be a DVD or Hi Def DVD player, or a computer, an appropriate server, or by any device, method, or means commonly employed to deliver video.

The video signal may include a header or some other means of cueing the interdigitation function. In the event that planar images are desired to be played on the monitor then the interdigitation function is turned off, whereas if an autostereoscopic image is required then the interdigitation function is turned on. As a result the transition from stereo content to planar content can be transparent to the user. Such a monitor may follow the design recommendations given in U.S. patent application Ser. No. 11/400,958, “Autostereoscopic Display with Planar Pass-through,” filed Apr. 7, 2006, the entirety of which is hereby incorporated by reference. Other monitor conventions and designs may be employed while still within the scope of the present invention.

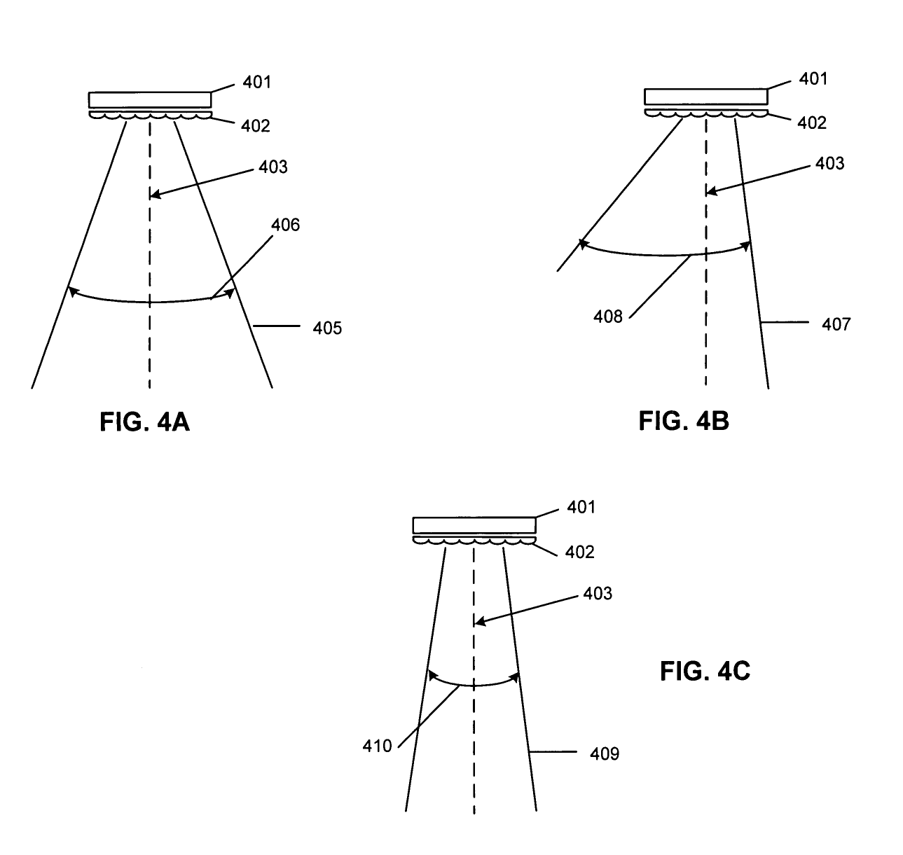

The accurate juxtaposition of the lens sheet with respect to the sub-pixels, as described above, is no small matter. If, for example, 304, being an exploded cross-sectional view of 302, in FIG. 3B is shifted even a small amount to the left or the right, with respect to the subpixels 305, the result required as illustrated in FIG. 4A may not be achieved. In FIG. 4A display 401 plus lens sheet 402 are present. Axis 403 is a line dropped perpendicular to the center of the plane of the display 401 and the lens sheet 402. Since the lens sheet and the display are parallel, an axis perpendicular to one is perpendicular to the other. The viewing zone 405 has an angular extent 406, and the viewing zone 405 is bilaterally symmetrical about the axis. By definition, viewing zone 405 is properly centered. FIG. 4B shows the result of not having the lens sheet properly juxtaposed with respect to the pixel display. In other words, if 304 is slightly shifted with respect to 305 with regard to alignment lenslets and subpixels, the result is shown as in FIG. 4B in which the viewing zone 407 is shifted. For the purposes of this illustration, the angular extent of 408 is shifted to the left, but it might be to the right. Such shifting is undesirable, because viewers who place themselves in front of the monitor expect to see a proper stereoscopic image, and shifting does not enable such viewing.

Panoramagrams produce repeating patterns of viewing zones. The present discussion has only shown, for example, the central viewing zone 406. Viewing zones exist on either side—secondary and tertiary and additional zones—which form a symmetrical pattern. But the central viewing zone is preferably properly centered to meet the viewer's expectations. Previous designs could only center using mechanical alignment, by laterally shifting or by rotating lens sheet 302 or 304 with respect to the underlying display 301 or 305. By incorporating the interdigitation processing within the monitor as shown in FIG. 2 using interdigitation board 208, the present design aligns the monitor, with the alignment performed by a software adjustment.

One such alignment technique is illustrated in U.S. Pat. No. 6,519,088, which is hereby incorporated by reference. The alignment technique resembles optical interferometry. Proper alignment cannot be achieved through ordinary measurement techniques, but must be done by observing a kind of optical pattern as described in the '088 patent. This pattern, by means of an operator or by a machine, produces the desired calibration result. Previously such adjustment came about by a movement of the lens sheet with respect to the display. Such alignment can also be achieved by software. By laterally shifting or rotating the image incrementally through software shifting of the image, an operator or a machine can observe a pattern and then make changes to the interdigitation constants which can be added in memory to and employed by the interdigitation board 208. The purpose of all of this is, of course, as mentioned, to provide a central viewing zone, which is what we call symmetrical or properly centered. Such an approach can work best if the interdigitation process is part of the monitor since the juxtaposition constants are best located integrally as part of the monitor.

As noted, the lens sheet and the display, for the first hour of operation, go through dimensional changes. After about an hour these components reach a steady state, and there is then a fixed juxtaposition of the individual lens elements with the sub-pixels and the columns and stripes that have been formed by the interdigitation process. But during this hour, given that initial interdigitation constants are employed for room temperature setup, the extent of the viewing zone is reduced until the monitor comes up to operating temperature. FIG. 4C shows the viewing zone 409 reduced, as represented by angle 410, with respect to angle 406 in FIG. 4A. The cure, then, is to understand the differential expansion of the lens sheet/display ensemble, to either use a thermocouple or a strict time and heuristic method to adjust the interdigitation process to maintain the relative juxtaposition of the sub-pixels with regard to the lenticules. Thus on a continuous basis in the first hour or so of operation, the system can maintain a proper juxtaposition of sub-pixels with regard to the lens sheet, and thereby keep the angular extent of the viewing zone constant.

With respect to compensating for temperature changes, reference is made to the currently co-pending U.S. patent application entitled “Temperature Compensation for the Differential Expansion of an Autostereoscopic Lenticular Array and Display Screen,” inventors Lenny Lipton and Robert Akka, filed Oct. 26, 2006, Attorney Docket REAL0122. Teachings from this Temperature Compensation application may be employed in the present design, and the entirety of the Temperature Compensation application is hereby incorporated by reference.

Alignment is greatly simplified because of software adjustment of the lens sheet with respect to the pixels. The only thing needed to shift in such a case is the location of the pixels with respect to the lens sheet, and thus there needs to be no mechanical adjustment. The central view zone may be properly placed so that it favors neither the left nor the right side of the monitor. The angular extent of the viewing zone is controlled while the monitor warms up, so that the angular extent of the viewing zone is constant. By either measurement of temperature or strictly on a time basis based on experiment, the system keeps the relative juxtaposition of the sub-pixels and the lens sheet constant by adjusting, in effect, the pitch of the sub-pixels which are formed into columns by means of the interdigitation algorithm. This keeps the viewing zone's angular extent constant. The result is an autostereoscopic monitor which, when turned on, functions well from the moment it is turned on until it is turned off.

The design presented herein and the specific aspects illustrated are meant not to be limiting, but may include alternate components while still incorporating the teachings and benefits of the invention. While the invention has thus been described in connection with specific embodiments thereof, it will be understood that the invention is capable of further modifications. This application is intended to cover any variations, uses or adaptations of the invention following, in general, the principles of the invention, and including such departures from the present disclosure as come within known and customary practice within the art to which the invention pertains.

What is claimed is:

1. In an autostereoscopic system wherein video content is provided in a video source format to a video display having a lenticular screen arranged in juxtaposition with the display, an improvement comprising an interdigitation module incorporated as part of an electronics module associated with the video display, wherein the interdigitation module receives the video content in the video source format and maps the video content in the video source format into multiple perspectives of an autostereoscopic image.

2. The autostereoscopic system of claim 1, wherein the video source format comprises one from a group comprising:
n-tile format;
stereo pair; and
planar view plus depth map.

3. The autostereoscopic system of claim 2, wherein the video content is in one from a group comprising NTSC, PAL, and high definition format.

4. The autostereoscopic system of claim 1, wherein the video content in the video source format is scaled before receipt by the interdigitation module.

5. The autostereoscopic system of claim 1, wherein the interdigitation module is configured to compensate for temperature changes to the video display and a lenticular screen placed in juxtaposition with the video display.

6. The autostereoscopic system of claim 5, wherein the interdigitation module compensates for temperature changes by altering selected pixel positions such that a central viewing zone in front of the lenticular screen provides good viewing characteristics for the temperature change anticipated.

7. An autostereoscopic system, comprising:
a video source configured to provide video content in a video source format; and
a monitor system coupled to the video source and configured to receive the video content in the video source format, the monitor system comprising:
an interdigitation module configured to receive the video content in the video source format and interdigitate the video content in the video source format into an autostereoscopic image;
a video rendering module coupled to the interdigitation module configured to receive the autostereoscopic image from the interdigitated module and provide a rendered autostereoscopic image;
a display coupled to the video rendering module and configured to receive the rendered autostereoscopic image; and
a lenticular screen held in juxtaposition with the display.

8. The autostereoscopic system of claim 7, wherein the video source format comprises one from a group comprising:
n-tile format;
stereo pair; and
planar view plus depth map.

9. The autostereoscopic system of claim 8, wherein the video content is in one from a group comprising NTSC, PAL, and high definition format.

10. The autostereoscopic of claim 7, wherein the video content in the video source format is scaled before receipt by the interdigitation module.

11. The autostereoscopic system of claim 7, wherein the interdigitation module is configured to compensate for temperature changes to the video display and the lenticular screen placed in juxtaposition with the video display.

12. The autostereoscopic system of claim 11, wherein the interdigitation module compensates for temperature changes by altering selected pixel positions such that a central viewing zone in front of the lenticular screen provides good viewing characteristics for the temperature change anticipated.

13. The autostereoscopic system of claim 7, wherein the monitor system further comprises a monitor housing comprising the interdigitation module, the video rendering module, and the display.

14. The autostereoscopic system of claim 7, wherein the monitor system further comprises a monitor housing comprising the video rendering module and the display, and the interdigitation module comprises a separate interdigitation device located external to the monitor housing.

15. An autostereoscopic display system, comprising:
an interdigitation module configured to receive the video content in the video source format and interdigitate the video content in the video source format into an autostereoscopic image;
a video rendering module coupled to the interdigitation module configured to receive the autostereoscopic image from the interdigitated module and provide a rendered autostereoscopic image;
a display coupled to the video rendering module and configured to receive the rendered autostereoscopic image; and
a lenticular screen held in juxtaposition with the display.

16. The autostereoscopic display system of claim 15, wherein the video source format comprises one from a group comprising:
n-tile format;
stereo pair; and
planar view plus depth map.

17. The autostereoscopic display system of claim 15, wherein the video content is in one from a group comprising NTSC, PAL, and high definition format.

18. The autostereoscopic display system of claim 17, wherein the video content in the video source format is scaled before receipt by the interdigitation module.

19. The autostereoscopic display system of claim 15, wherein the interdigitation module is configured to compensate for temperature changes to the video display and the lenticular screen placed in juxtaposition with the video display.

20. The autostereoscopic display system of claim 15, wherein the interdigitation module compensates for temperature changes by altering selected pixel positions such that a central viewing zone in front of the lenticular screen provides good viewing characteristics for the temperature change anticipated.
